(19) United States
(12) Patent Application Publication
(10) Pub. No.: US 2016/0154349 A1
(43) Pub. Date: Jun. 2, 2016

(54) IMAGE HEATING APPARATUS AND IMAGE FORMING APPARATUS

(71) Applicant: CANON KABUSHIKI KAISHA, Tokyo (JP)

(72) Inventor: Taku Higashiyama, Yokohama-shi (JP)

(21) Appl. No.: 14/948,564

(22) Filed: Nov. 23, 2015

(30) Foreign Application Priority Data
Nov. 28, 2014 (JP) 2014-241214

(51) Int. Cl. G03G 15/20

(52) U.S. Cl. CPC G03G 15/2039

(57) ABSTRACT

A heating rotator includes a rubber layer containing 10 to 60 volume % of at least one of magnetic particles of iron, nickel, cobalt, γ-iron oxide, alnico, ferrite, and neodymium, and heats a toner image formed on a recording material at a nip portion. A control portion controls density of magnetic flux acting on the rubber layer from a magnetic flux generate portion.

### BACKGROUND OF THE INVENTION

1. Field of the Invention

The present invention relates to an image heating apparatus heating a toner image formed on a recording material and to an image forming apparatus such as a copier, a printer, a facsimile, and a multi-function printer.

2. Description of the Related Art

There is widely used an image forming apparatus configured to form a toner image, to transfer the toner image onto a recording material, and to fix the toner image on the recording material by heating and pressing the recording material onto which the toner image has been transferred by a fixing apparatus (image heating apparatus). The fixing apparatus enhances followingness to irregularities of a surface of the recording material by providing an elastic layer on a roller or an endless belt being in contact with a toner image bearing face of the recording material as disclosed in Japanese Patent Application Laid-open Nos. 2001-154525 and 2005-242113 for example.

Japanese Patent Application Laid-open No. 2001-154525 discloses a fixing apparatus in which a recording material nip portion is formed by bringing a heating roller provided with an elastic layer into pressure contact with a pressure roller provided with an elastic layer. The fixing apparatus enhances followingness of the heating roller to the irregularities of the surface of the recording material by enhancing a pressing force applied to the nip portion between the heating and pressure rollers to a recording material of which surface roughness is large.

‘A model of the behavior of magnetorheological materials’ Jolly, M. R. et. al., Smart Mater Struct. Vol. 5, (1996), 66. pp. 607-614 discloses a manufacturing method of a magnetic rubber material (magnetic elastomer) in which magnetic particle is blended into elastomer. This article reports that hardness, rigidity, and elastic modulus of the magnetic rubber material are enhanced by applying a magnetic field to the magnetic rubber material.

The followingness of the surface of the roller or the endless belt to the irregularities of the surface of the recording material is almost determined by a material of the elastic layer. It is preferable to form the elastic layer by a soft rubber material to a recording material of which surface roughness is large and by a hard rubber material to a recording material of which surface roughness is small.

### SUMMARY OF THE INVENTION

This disclosure provides a configuration capable of favorably conducting a heating process on a toner image both on a recording material to which a soft rubber layer is preferable and on a recording material to which a hard rubber layer is preferable.

According to first aspect of the present invention, there is provided an image forming apparatus including a heating rotator configured to heat a toner image formed on a recording material at a nip portion, the heating rotator including a rubber layer containing 10 to 60 volume % of at least one of magnetic particles of iron, nickel, cobalt, γ-iron oxide, alnico, ferrite, and neodymium, a magnetic flux generate portion configured to generate magnetic flux, and a control portion configured to control density of the magnetic flux acting on the rubber layer from the magnetic flux generate portion.

According to second aspect of the present invention, there is provided an image forming apparatus including a first rotator including a rubber layer in which magnetic particles are dispersed and configured to come into contact with a surface on a side of bearing a toner image of a recording material, a second rotator configured to form a nip portion nipping the recording material between the first and second rotators, a heating portion configured to heat the first rotator to heat a toner image formed on the recording material at the nip portion, a magnetic flux generate portion configured to generate magnetic flux incident into the rubber layer at the nip portion, and a switching portion configured to switch density of the magnetic flux generated by the magnetic flux generate portion and being incident into the magnetic rubber layer.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of an image forming apparatus of a first embodiment.

FIG. 2 is a section view schematically illustrating a configuration of a fixing apparatus of the first embodiment.

FIG. 3 is an enlarged view of one longitudinal end portion of the fixing apparatus of the first embodiment.

FIG. 4 is a perspective view of a test piece.

FIG. 5 is a schematic diagram illustrating a configuration of a testing device.

FIG. 6 is a graph illustrating a relationship between an inter-magnet pole distance and magnetic flux density.

FIG. 7A illustrates a position of an eccentric cam of an adjustment mechanism when an opposed distance is 15 mm.

FIG. 7B illustrates a position of the eccentric cam of the adjustment mechanism when the opposed distance is 10 mm.

FIG. 7C illustrates a position of the eccentric cam of the adjustment mechanism when the opposed distance is 5 mm.

FIG. 8 is a flowchart of a fixing process of the first embodiment.

FIG. 9 is a flowchart of another fixing process of the first embodiment.

FIG. 10 is a graph illustrating a relationship between indices of hardness M, temperature difference ΔT and heating time t.

FIG. 11 is a section view schematically illustrating a configuration of a fixing apparatus of a second embodiment.

FIG. 12 is a section view schematically illustrating a configuration of a fixing apparatus of a third embodiment.

FIG. 13A is a section view schematically illustrating a configuration of a fixing apparatus of a fourth embodiment.

FIG. 13B is a section view schematically illustrating a configuration of another exemplary fixing apparatus of the fourth embodiment.

FIG. 14 is a section view schematically illustrating a configuration of a fixing apparatus of a fifth embodiment.

FIG. 15 is a section view schematically illustrating a configuration of another exemplary fixing apparatus of the fifth embodiment.

### DESCRIPTION OF THE EMBODIMENTS

### First Embodiment

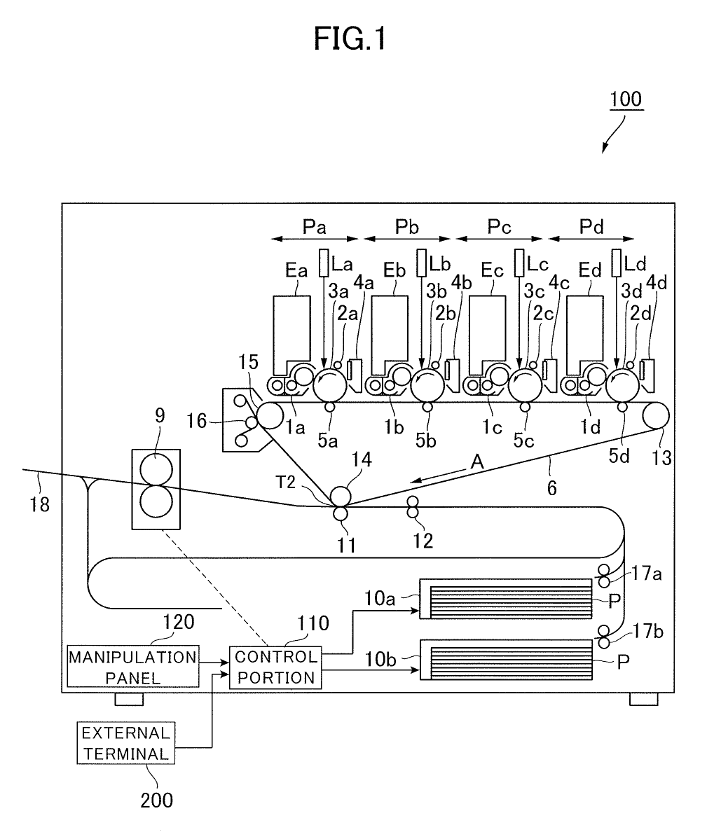

An image forming apparatus of a first embodiment will be described with reference to FIGS. 1 through 10.

### Image Forming Apparatus

FIG. 1 schematically illustrates a configuration of the image forming apparatus 100 of a first embodiment. As shown in FIG. 1, the image forming apparatus 100 is a tandem intermediate transfer type full-color printer in which image forming portions Pa, Pb, Pc, and Pd of yellow, magenta, cyan, and black are disposed along an intermediate transfer belt 6. The intermediate transfer belt 6 and the image forming portions Pa, Pb, Pc, and Pd, i.e., exemplary toner image forming portions, form toner images and transfer the toner images onto a recording material.

The image forming apparatus 100 executes an image forming operation corresponding to image information inputted from an external terminal 200 communicably connected with a control portion 110. The external terminal 200 is a computer, an image reader, or the like. The control portion 110 executes an image forming sequence by exchanging data and commands with the external terminal 200 and by controlling mechanisms and circuits of the image forming apparatus 100.

In the image forming portion Pa, a yellow toner image is formed on a photosensitive drum 3a and is transferred onto the intermediate transfer belt 6. In the image forming portion Pb, a magenta toner image is similarly formed on a photosensitive drum 3b and is transferred onto the intermediate transfer belt 6. In the image forming portions Pc and Pd, cyan and black toner images are formed respectively on photosensitive drums 3c and 3d and are then transferred onto the intermediate transfer belt 6.

The four color toner images transferred onto the intermediate transfer belt 6 are conveyed to a secondary transfer portion T2 and are secondarily transferred onto the recording material P. A separation roller 17a (17b) separates the recording material P one by one from a recording material cassette 10a (10b) and delivers to a registration roller 12. The registration roller 12 sends the recording material P to the secondary transfer portion T2 in synchronism with the toner image on the intermediate transfer belt 6. The recording material P on which the four color toner images have been secondarily transferred undergoes a heating process in a fixing apparatus 9, i.e., an image heating apparatus, such that the toner images are fixed on the surface of the recording material P. After that, the recording material P is discharged out of the image forming apparatus 100 to a discharge tray 18 in a case of simplex printing.

### Image Forming Portion

The image forming portions Pa, Pb, Pc, and Pd are configured to be substantially same except that colors of toners used in developing devices 1a, 1b, 1c and 1d are different as yellow, magenta, cyan, and black. Therefore, only the image forming portion Pa will be described below and overlapped description of the other image forming portions Pb, Pc, and Pd will be omitted.

The image forming portion Pa includes a charging device 2a, an exposure device La, the developing device 1a, a transfer roller 5a, and a drum cleaning device 4a which are arranged around a photosensitive drum 3a. The photosensitive drum 3a includes a photosensitive layer formed around an outer circumferential surface of a cylinder made of aluminum and rotates in a direction of an arrow shown in FIG. 1 at predetermined processing speed.

The charging device 2a charges the photosensitive drum 3a with homogeneous negative potential. The exposure device La scans a laser beam of ON-OFF modulated scan line image signals in which each color image is developed by a polygonal mirror to draw an electrostatic latent image on the photosensitive drum 3a. The developing device 1a applies electrified toner to the photosensitive drum 3a to develop the electrostatic latent image as a toner image. A toner cartridge Ea supplies an amount of toner corresponding to an amount of toner consumed for an image forming operation.

The transfer roller 5a presses the intermediate transfer belt 6 and forms a toner image transfer portion between the photosensitive drum 3a and the intermediate transfer belt 6. The negative toner image borne by the photosensitive drum 3a is transferred onto the intermediate transfer belt 6 by positive DC voltage applied to the transfer roller 5a.

The intermediate transfer belt 6 is wrapped around and supported by a tension roller 15, a secondary transfer inner roller 14, and a driving roller 13, and rotates in a direction of an arrow A in FIG. 1 by being driven by the driving roller 13. A secondary transfer roller 11 is in contact with the intermediate transfer belt 6 being supported by the secondary transfer inner roller 14 and forms the secondary transfer portion T2. The toner image on the intermediate transfer belt 6 is transferred to the recording material P by positive DC voltage applied to the secondary transfer roller 11.

The drum cleaning device 4a collects transfer residual toner left on the photosensitive drum 3a by scrubbing the photosensitive drum 3a by a cleaning blade. A belt cleaning device 16 collects transfer residual toner left on the intermediate transfer belt 6 by scrubbing the intermediate transfer belt 6 by a cleaning web.

### Fixing Apparatus

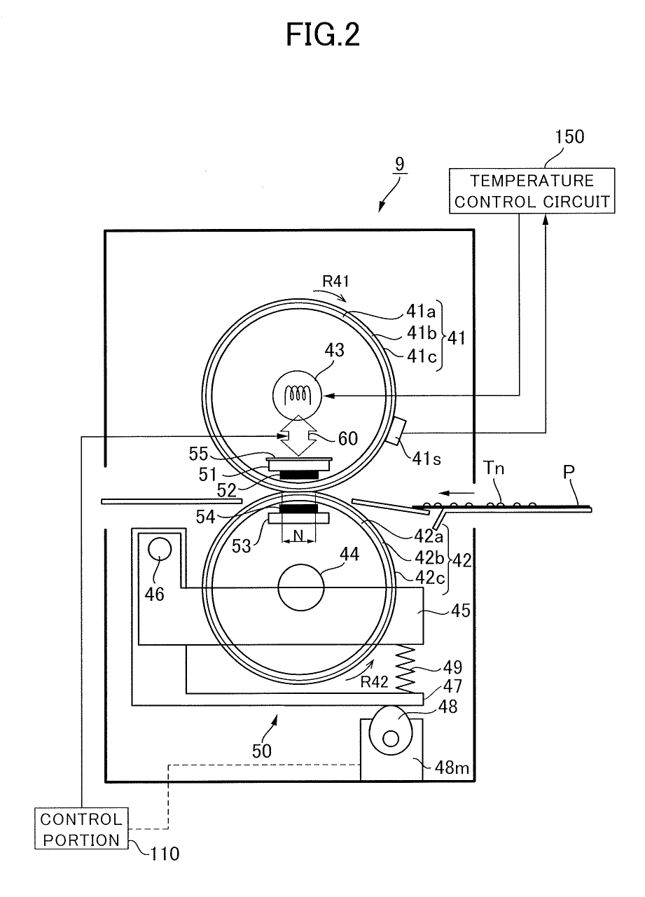

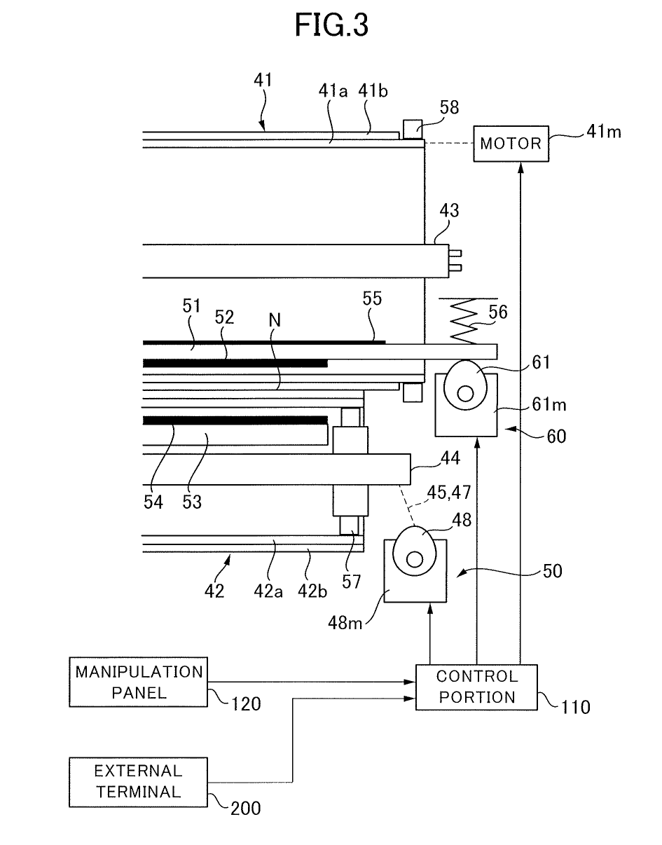

FIG. 2 illustrates a configuration of the fixing apparatus 9. FIG. 3 is an enlarged view of one end portion of the fixing apparatus 9. As shown in FIG. 2, the fixing apparatus 9 fixes the toner image Tn on the recording material P by nipping and conveying the recording material P bearing the toner image through a nip portion N between a fixing roller 41 and a pressure roller 42.

The fixing apparatus 9, i.e., one exemplary image heating apparatus in the image forming apparatus, heats the recording material on which the toner image has been transferred to melt the toner and then to solidify the toner to fix the image on the recording material. The fixing apparatus is roughly categorized into a contact type fixing apparatus and a non-contact type fixing apparatus. The contact type fixing apparatus brings a heated roller or an endless belt into contact with a non-fixed toner image to soften the toner to fix on the recording material. Because the contact type fixing apparatus can soften black and color toners homogeneously, this type is a main stream in these days.

The fixing roller 41, i.e., one example of a heating rotator and a first rotator, includes a rubber layer (magnetic rubber layer) made of a magnetic rubber material in which magnetic particles are dispersed within a rubber material and comes into contact with a surface on a side of the recording material P bearing the toner image. The fixing roller 41 is formed by providing the magnetic rubber layer (elastic layer) 41b made of the magnetic rubber material around a core metal (base layer) 41a made of a non-magnetic metallic material and by coating a releasing layer 41c made of a fluororesin material around a circumferential surface of the magnetic rubber layer 41b. Elastomer of heat-resistant silicon rubber, fluororubber, or the like is used as a base of the magnetic rubber layer 41b. The magnetic rubber layer 41b has high heat conductivity so as to transmit heat from the core metal 41a to the recording material P besides softness capable of following the roughness of the surface of the recording material P. To that end, it is possible to add fillers such as SiC, ZnO, Al₂O₃, AlN, MgO, carbon, or the like within the silicon rubber of the magnetic rubber layer 41b. Several kinds of substances may be used for the fillers. The provision of the magnetic rubber layer 41b makes it possible for the magnetic rubber layer 41b to deform corresponding to the irregularities of the surface of the recording material P and hence to apply heat and pressure homogeneously to a non-fixed toner when the recording material P passes through the nip portion N.

It is also possible to use a sponge material or the like obtained by foaming fluororesin rubber and silicon rubber, besides the silicon rubber, as the base of the magnetic rubber layer 41b. The magnetic rubber layer 41b is preferable to be around 200 μm to 3 mm thick. A releasing layer 41c made of a fluororesin material is formed on the surface of the magnetic rubber layer 41b to enhance melt toner releasability. Although the thinner, the better the followability of the releasing layer 41c to the irregularities of the surface of the recording material becomes due to the softness of the elastic layer, the releasing layer 41c is preferable to be around 10 μm to 100 μm thick by considering durability and others. PFA resin (copolymer of polytetrafluoroethylene resin and perfluooroalkoxy ethylene resin), PTFE (polytetrafluoroethylene resin), or the like which excels in releasability is used for the releasing layer 41c.

A halogen lamp 43, i.e., one exemplary heating portion, is non-rotationally disposed along a rotation axial direction within the fixing roller 41 and heats the fixing roller 41. The halogen lamp 43 heats the fixing roller 41 to heat the toner image formed on the recording material and the heated fixing roller 41 fixes the toner image on the recording material at the nip portion N described later. A temperature sensor (thermistor) 41s is disposed so as to be in contact with the surface of the fixing roller 41. A temperature control circuit 150 is provided to adjust power inputted to the halogen lamp 43 such that temperature detected by the temperature sensor 41s is kept around 150 to 180° C., i.e., target temperature by which the toner image can be fixed to the recording material P. The target temperature differs depending on a type of the recording material and others. The fixing roller 41 rotates in a direction of an arrow R41 (see FIG. 2) by being driven by a motor 41m (see FIG. 3). Peripheral speed of the fixing roller 41 corresponds to process speed (image output speed) of the image forming apparatus 100 and is 220 mm/sec. here.

The pressure roller 42, i.e., one exemplary second rotator, forms the nip portion N between the fixing roller 41 to nip the recording material and to fix the toner image on the recording material. The pressure roller 42 is formed by providing an elastic layer 42b made of a rubber material around a core metal (base layer) 42a made of a non-magnetic metallic material and by coating a releasing layer 42c made of a fluororesin material around a circumferential surface of the elastic layer 42b. That is, the pressure roller 42 is formed by molding the elastic layer 42b of 20° of rubber hardness (JIS-A, 1 kg weighting) to be 1.0 mm thick around the core metal 42a formed of an aluminum-made cylinder of 38 mm in an outer diameter and 1.0 mm thick and by coating the releasing layer 42c made of the fluororesin of 50 μm thick around the surface of the elastic layer 42b. Then, the outer diameter of the pressure roller 42 is made to be 40 mm in total.

It is noted that the elastic layer of the fixing roller 41/pressure rollers 42 is bonded with the releasing layer and the core metal, respectively, by using adhesive. Thermal physical values of the adhesive are close to those of the elastic layer, and thickness of the adhesive is very thin as compared to those of the releasing layer, the elastic layer, and the core metal, so that an influence of the adhesive is negligible in terms of thermal resistance.

The pressure roller 42 is driven by the fixing roller 41 by being in contact with the fixing roller 41. It is possible to bring the pressure roller 42 into contact with/separate from the fixing roller 41 and to adjust the pressurizing force of the nip portion N by elevating/lowering the pressure roller 42 by a contact/separation mechanism 50. A shaft member 44 is disposed non-rotationally at a center of rotation of the pressure roller 42. The shaft member 44 is fixed to a lever member 45 turnable around a rotating shaft 46 and is turnable centering on the rotating shaft 46. A turning base is also turnable around the rotating shaft 46. A pressure spring 49 is disposed between an end of the lever member 45 and an end of the turning base 47. Both end portions of the shaft member 44 are biased upward by the pressure spring 49 through the lever member 45, and thus the pressure roller 42 forms the nip portion N between the fixing roller 41.

An eccentric cam 48 is driven by a gear motor 48m and elevates/lowers the end of the turning base 47. Corresponding to a phase angle of the rotation of the eccentric cam 48, the pressure roller 42 separates from the fixing roller 41, comes into contact with the fixing roller 41, or changes a contact pressure with respect to the fixing roller 41. The pressure roller 42 comes into pressure contact with the fixing roller 41 with a predetermined pressure and forms the nip portion N having a predetermined length in a rotation direction. Here, the pressure roller 42 is pressed to the fixing roller 41 by up to 800 N in maximum in total.

As shown in FIG. 3, the fixing roller 41 is rotatably supported by bearings 58 provided at both end portions in the rotation axial direction of the core metal 41a. The pressure roller 42 is rotatably supported by bearings 57 provided inside of both end portions in the rotation axial direction of the core metal 42a.

Here, toner image fixability of the fixing apparatus varies depending on setting of temperature of the fixing roller, a stay time of the recording material P in the nip portion N, irregularities of the surface of the recording material P, thickness of the recording material P, thermal physical values of the recording material P, and others. Then, the surface of the fixing roller is desirable to be soft for a recording material of which surface roughness is large (so-called a rough sheet) in order to melt toner fallen between fibers of the sheet, as compared to a plain sheet of which surface roughness is small. However, it is not practical to prepare a soft fixing roller and a less soft fixing roller in the fixing apparatus and to replace the fixing rollers per recording material of which surface roughness is different. Then, in order to solve this problem, it has been proposed to change the pressurizing force of the nip portion N between the fixing roller and the pressure roller in response to the recording material of which surface roughness is large as disclosed in Japanese Patent Application Laid-open No. 2001-154525. However, even if the pressurizing force is increased to deal with the recording material of which surface roughness is large by the same fixing roller, a range of the surface roughness in which the fixing roller can follow is limited.

Then, according to the first embodiment, the elastic layer of the fixing roller 41 is formed of the magnetic rubber material to be able to adjust hardness of the surface of the fixing roller 41 by applying a variable magnetic field to the elastic layer.

### Test

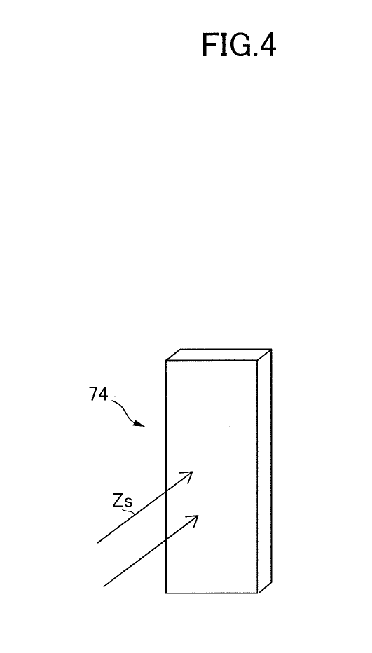

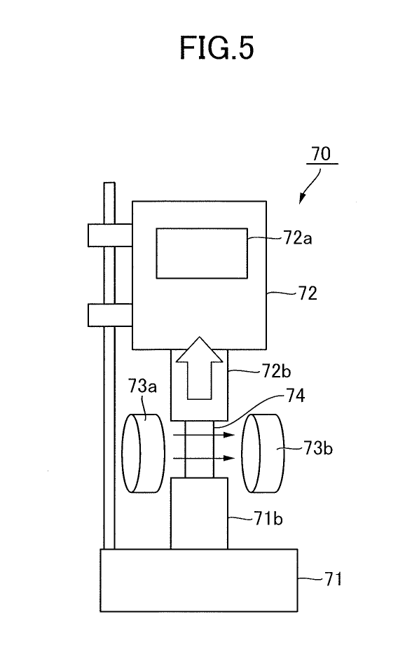

Tests carried to confirm whether the required change of hardness can be achieved in the magnetic rubber material by applying a magnetic field will be described below with reference to FIGS. 4 and 5. In the tests, a test piece as shown in FIG. 4 was made from the magnetic rubber material using magnetic particles, and a testing device capable of applying a magnetic field as shown in FIG. 5 was used to study physical properties of the magnetic rubber material.

The magnetic rubber material can be prepared by blending fine powder of iron Fe, nickel Ni, cobalt Co, or iron oxide Fe₃O₄, i.e., filler of magnetic particles, into a heat-resistant rubber material such as silicon rubber. Here, silicon rubber was used as a base material of the magnetic rubber material, and fine powder of nickel Ni (average diameter was 300 μm) was used as the magnetic particles. The Ni fine powder was added up to 40% in volume ratio. The silicon rubber may be Silpot 184 (Dow Corning Co., Ltd.), KE3475T and KE103 (Shin-Etsu Chemical Co., Ltd.) for example.

The following process was adopted in fabricating the test piece of the magnetic rubber material:

(1) After mixing curing agent into the silicon rubber with a predetermined ratio and agitating them, vacuum degassing was conducted by a rotary pump or the like;

(2) The magnetic particles of nickel Ni was added into the silicon rubber, and the silicon rubber agitated with the magnetic particles was injected into a mold of the test piece. After injecting the silicon rubber into the mold, the vacuum degassing was conducted again, and the silicon rubber was thermally hardened by heating for one hour in an oven of 80° C.;

(3) The test piece of the magnetic rubber material was formed into a cube of 10 mm×30 mm×2.5 mm to use as a test piece of a tensile testing device.

As shown in FIG. 5, the tensile testing device 70 adapted to be able to apply a magnetic field was used to measure an apparent Young's modulus of the magnetic rubber material test piece 74.

The tensile testing device 70 includes a strength gage (measure portion 72) capable of elevating/lowering with respect to a base 71. Permanent magnets 73a and 73b are disposed such that magnetic pole surfaces of reverse magnetic poles face with each other while interposing the magnetic rubber material test piece 74 without contact in a direction of thickness thereof. A pair of ferrite magnets whose magnetic flux density was 200 mT was used for the permanent magnets 73a and 73b. The permanent magnets 73a and 73b make magnetic flux being incident to the magnetic rubber material test piece 74 in the thickness direction thereof.

A lower end of the magnetic rubber material test piece 74 made in trial was fixed to the base 71, and an upper end of the magnetic rubber material test piece 74 was fixed to the measuring portion 72. In response to a manipulation of a measurement starting switch of the tensile testing device 70, the measuring portion 72 elevates at certain speed to increase a tensile load applied to the magnetic rubber material test piece 74. During that process, the measuring portion 72 outputs data of a tensile force, a cross sectional area of the test piece, and stress moment to moment.

The tensile tests were carried out in the condition in which the magnetic field of a plurality of stages of strength was applied to each of five magnetic rubber material test pieces 74 by using the permanent magnets 73a and 73b. The apparent elastic modulus (Young's modulus) was found from measured results as follows.

When a tensile strain of the magnetic rubber material test piece 74 is small, elasticity of the rubber is linearity. The apparent elastic modulus Em in the elasticity of rubber can be calculated as follows:

Em=σm÷δm=F/A÷Δm/L Eq. 1

where, σm is a tensile stress, δm is a strain amount, F is a tensile force, A is a cross sectional area of the test piece of the magnetic rubber material, and L is an original length of the test piece.

In the condition in which the permanent magnets 73a and 73b were attached, rigidity of the magnetic rubber material test piece 74 was enhanced and the magnetic rubber material test piece 74 became hard as compared to that in a condition in which the permanent magnets 73a and 73b were detached. Still further, when an opposed distance (inter-magnet pole distance) of the permanent magnets 73a and 73b was reduced to bring the permanent magnets 73a and 73b closer to the surfaces of the magnetic rubber material test piece 74, the apparent elastic modulus Em of the magnetic rubber material test piece 74 were enhanced.

This phenomenon is considered to have occurred because the strong magnetic field acts on the magnetic particles within the magnetic rubber material test piece 74 and the magnetic particles are rearranged within the elastomer by magnetically coupling with each other as described in ‘A model of the behavior of magnetorheological materials’ Jolly, M. R. et. al., Smart Mater Struct. Vol. 5, (1996), 66. Pp. 607-614.

When the opposed distance between the permanent magnets 73a and 73b was increased to be distant from the surfaces of the magnetic rubber material test piece 74, the magnetic rubber material test piece 74 was softened and the apparent elastic modulus Em of the magnetic rubber material test piece 74 returned to its original value. This phenomenon is considered to have occurred because the magnetic coupling of the magnetic particles within the magnetic rubber material test piece 74 is eliminated.

Table 1 shows the measured results of the changes of the apparent elastic modulus Em of the magnetic rubber material test piece 74 corresponding to the conditions in which the magnetic field was applied and in which no magnetic field was applied by the permanent magnets 73a and 73b. Numerical values in Table 1 were calculated by Equation 1 from the measured results of the tensile tests.

TABLE 1

| MAGNETIC FIELD | APPLIED | NOT APPLIED |
|---|---|---|
| APPARENT ELASTIC | 0.31 | 0.27 |
| MODULUS [MPa] | | |

### Physical Properties of Magnetic Rubber Material

Regarding the magnetic rubber material in which the magnetic particles are dispersed within the elastomer, ‘A model of the behavior of magnetorheological materials’ Jolly, M. R. et. al., Smart Mater Struct. Vol. 5, (1996), 66. Pp. 607-614 reports about a relationship between modulus of rigidity and magnetic flux density.

In this document, Jolly, et. al., calculated magnetic energy E from an inter-particle distance r₀ of magnetic particles, inter-particle displacement x, and a moment of dipole m within the elastomer.

$$E = \frac{{\vert m \vert}^{2} ( 1 - 3 \frac{{r}_{0}^{2}}{{r}_{0}^{2} + {x}^{2}} )}{4 {πμ}_{1} {{μ}_{0} ( {r}_{0}^{2} + {x}^{2} )}^{3 / 2}} \qquad Eq . 2$$

In Equation 2, μ₁ is magnetic permeability of the magnetic particle. μ₀ is magnetic permeability in vacuum. The strain ε can be expressed as follows:

ε=(1+(x/r₀)²)^{0.5}−1

Then, shearing modulus of rigidity G was calculated by second order differentiating the magnetic energy E by the strain ε:

$$G \approx \frac{φ {J}_{P}^{2}}{2 {μ}_{1} {μ}_{0} {h}^{3}} \qquad Eq . 3$$

In Equation 3, φ is a volume ratio of the magnetic particles. h is a ratio obtained by dividing the inter-particle distance r₀ by particle size d of the magnetic particle. J_{P} is an average particle polarization and is known to be proportional to an external magnetic field B. Equation 3 can be transformed into the following equation by using the magnetic flux density:

G∝B²

Still further, the shearing modulus of rigidity G and the elastic modulus E can be expressed as follows by using Poisson ratio γ:

$$G = \frac{E}{2 ( 1 + γ )} \qquad Eq . 4$$

Because the Poisson ratio γ is about 0.5 in a case of rubber, the apparent elastic modulus Em=3G from Equation 4. It can be seen from this equation that there is a relationship of ‘G∝Em’.

Therefore, a relationship of ‘Em∝B²’ is led from the relationship of ‘G∝B²’ and the apparent elastic modulus Em of the magnetic rubber material test piece 74 increases in proportion to a square of the applied magnetic flux density.

Still further, a change time of the magnetic coupling caused by the change of the magnetic field is 1 to 2 msec. in a case of magnetic fluid.

Because the magnetic rubber material tends to be solid as compared to the magnetic fluid and because speed of elastic wave propagating within solid is faster than that in fluid, a change time of the magnetic coupling of the magnetic rubber material test piece 74 is shorter than the change time of 1 to 2 msec. of the magnetic fluid. Because this value is fully shorter than 40 msec. of a time during which the recording material passes through the nip portion of a conventional fixing apparatus, it is possible to change the hardness of the elastic layer substantially instantially by the change of the magnetic field in the nip portion N.

### Fixing Roller

As shown in FIG. 2, the core metal 41a is formed of the non-magnetic metal such as aluminum or of the heat-resistant resin so that the magnetic field transmits through that. The core metal 41a is formed of the aluminum cylinder whose outer diameter is 38 mm and whose thickness is 1 mm in the present embodiment as described above.

The elastomer of the heat-resistant silicon rubber or fluororesin is used for the magnetic rubber layer 41b of the fixing roller 41. The fixing roller 41 was fabricated by blending the fine powder of iron Fe, nickel Ni, cobalt Co, or iron oxide Fe₃O₄, i.e., the magnetic particles, into the elastomer of silicon rubber as fillers and by using an conventional fixing roller fabrication method. The magnetic rubber layer 41b whose rubber hardness is 20° in the condition in which no magnetic field is applied (JIS-A, 1 kg weighting) was molded with a thickness of 1.0 mm. Then, the outer diameter of the fixing roller 41 was made to be 40 mm. Thus, the thickness of the magnetic rubber layer 41b is 1.0 mm in the first embodiment. A fluororesin tube in which the PFA resin was formed into a tube of 50 μm thick was used as the releasing layer 41c.

A heat reflecting mirror 55 is disposed between the halogen lamp 43 and the permanent magnet 52 such that infrared rays emitted from the halogen lamp 43 are not directly irradiated to the permanent magnet 52. The heat reflecting mirror 55 is desirable to be made of metal such as aluminum and gold whose infrared reflectance is high and which is mirror-polished to enhance the reflectance. It is noted that although the halogen lamp 43 cannot directly heat the nip portion N because the halogen lamp 43 is shaded by the heat reflecting mirror 55, it is possible to heat the entire fixing roller 41 from inside by heating the fixing roller 41 while rotating the fixing roller 41. Flux generating portion

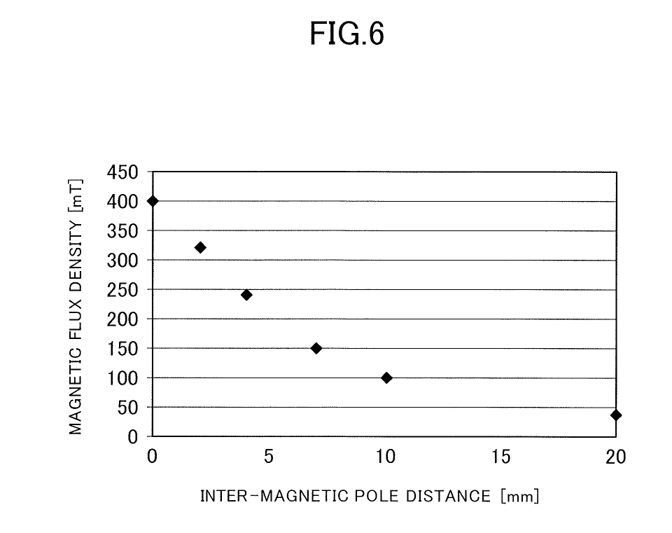

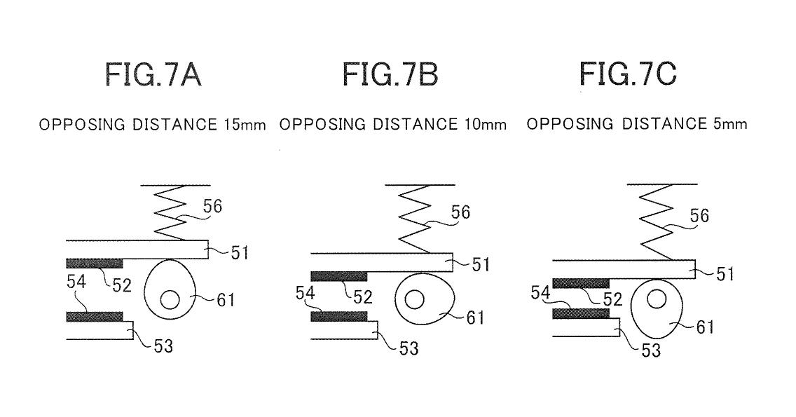

FIG. 6 is a graph illustrating the relationship between the opposed distance (inter-magnetic pole distance) of the permanent magnets and the magnetic flux density. FIGS. 7A, 7B, and 7C illustrate operations of the eccentric cam of an adjustment mechanism. As shown in FIG. 2, the fixing apparatus 9 applies the magnetic field to the magnetic rubber layer 41b of the fixing roller 41 by using permanent magnets 52 and 54, i.e., ferrite magnets, to make magnetic flux enter the magnetic rubber layer 41b based on the result of the test described above.

The permanent magnet 52, i.e., one exemplary first magnetic flux generate portion, is disposed within an inner space of the fixing roller 41. The permanent magnet 54, i.e., one exemplary second magnetic flux generate portion, is disposed within an inner space of the pressure roller 42 such that a magnetic pole different from that of the permanent magnet 52 face with each other while interposing the nip portion N. The permanent magnets 52 and 54 are not limited to be ferrite magnets, but may be ones adopted from neodymium magnets, samarium-cobalt magnets, alnico magnets, and others. Because the magnetic coupling of the magnetic rubber material can bring about an enough change of hardness of the rubber just by applying magnetic flux density of several hundreds millitesla from the results of the test, it is possible to deal with the magnetic flux density by all of these permanent magnets. Still further, although the magnetic flux density of the permanent magnet lowers in response to an increase of temperature of the magnet in general, a magnetic force enough for changing the hardness of the rubber is brought about by using the abovementioned magnets even in environmental temperature around 200° C. used in the fixing process. From an aspect of heat resistance, alnico magnet, ferrite magnet, and samarium-cobalt magnet are desirable in order of high Curie temperature. Still further, although neodymium magnet is weak to heat in general, there is one whose component has been improved to be heat resistant. It is also possible to use the improved neodymium magnet.

The permanent magnet 52 is fixed to a beam member 51 penetrating through the fixing roller 41 in the rotation axial direction such that the N-pole surface thereof faces an inner circumferential surface of the fixing roller 41. The permanent magnet 54 is fixed to a beam member 53 penetrating through the pressure roller 42 in the rotation axial direction such that the S-pole surface thereof faces an inner circumferential surface of the pressure roller 42. The magnetic field is generated between the N-pole surface of the permanent magnet 52 and the S-pole surface of the permanent magnet 54 and is applied to the magnetic rubber layer 41b. It is possible to enhance the magnetic flux density by two times or more by disposing the permanent magnets 52 and 54 such that the N-pole and S-pole face with each other.

In the fixing apparatus 9, the permanent magnet 52 is disposed movably on the inner circumferential surface of the fixing roller 41 at the nip portion N, and the permanent magnet 54 is disposed fixedly on the inner circumferential surface of the pressure roller 42. The adjustment mechanism 60 changes density of magnetic flux to be applied to the magnetic rubber layer 41b to change the hardness of the magnetic rubber layer 41b of the fixing roller 41 by moving the permanent magnet 52 in a height direction.

That is, the permanent magnet 52, i.e., one exemplary magnetic flux generate portion (first magnetic flux generate portion) and the permanent magnet 54, i.e., one exemplary second magnetic flux generate portion, generate the magnetic flux and make the magnetic flux being incident into the magnetic rubber layer 41b located at the nip portion N. The adjustment mechanism 60, i.e., one exemplary switching portion, is capable of switching the density of the magnetic flux incident into the magnetic rubber layer 41b made by the permanent magnets 52 and 54. That is, the adjustment mechanism 60 is a moving mechanism moving the permanent magnet 52 so as to change a distance between the permanent magnet 52 and the nip portion N.

As schematically shown in FIG. 3, the adjustment mechanism 60 uses an eccentric cam 61 as a mechanism moving the permanent magnet 52. The eccentric cam 61 is in contact with the beam member 51 biased by a return spring 56 and decreases the magnetic field passing through the magnetic rubber layer 41b by elevating the permanent magnet 52 while resisting against a bias force of the return spring 56 and attraction between the permanent magnets 52 and 54. The distance (the opposing distance) between the permanent magnets 54 and 52 changes depending on a rotational angle of the eccentric cam 61, and the magnetic flux with the magnetic flux density corresponding to the opposing distance between the permanent magnets 52 and 54 enter the magnetic rubber layer 41b. Therefore, the hardness of the magnetic rubber layer 41b changes and the followingness on the irregularities of the surface of the recording material P changes corresponding to the rotational angle of the eccentric cam 61.

As described above, the apparent elastic modulus Em of the magnetic rubber layer 41b is proportional to a square of the magnetic flux density B. Ideally, the Coulomb's law holds and there is a relationship of B∝1/d² between the magnetic flux density B and the opposing distance d between the permanent magnets 52 and 54.

However, according to the test described above, the relationship between the magnetic flux density B and the opposing distance d of the permanent magnets 52 and 54 deviates from the Coulomb's law, and the magnetic flux density B moderately decreased against an increase of the opposing distance d as shown in FIG. 6. Therefore, the control portion 110 sets the hardness of the magnetic rubber layer 41b based on the relationship between the opposing distance d and the magnetic flux density B shown in FIG. 6.

The control portion 110 sets the hardness of the magnetic rubber layer 41b conforming to the condition of the irregularities of the surface of the recording material by actuating a gear motor 61m corresponding to the type of the recording material specified from the manipulation panel 120 or the external terminal.

### Assessment of Fixability

A study was conducted on a relationship between fixability of an image fixed on recording materials of two types of sheets and the hardness of the magnetic rubber layer 41b in the image forming apparatus 100. That is, an experiment was carried out to study whether or not toner fallen into fibers of the sheet can be fully melt in the following two types of recording materials whose weights per unit area (basis weight) are equal and height of micro irregularities of the surface (surface roughness) is different. The two types of the recording materials used were: recording material A: XX4200 (manufactured by XEROX Co., Ltd., 105 g/m²) and recording material B: CLC105 (manufactured by Canon Inc., 105 g/m²). The height of the irregularities of the surface of the recording material A was higher than that of the recording material B. That is, the surface roughness of the recording material A was large. A toner image whose toner deposition amount was 0.6 mg/cm² was transferred onto the recording materials A and B and was fixed by setting temperature of the fixing apparatus 9 at 180° C. Table 2 shows the assessment results.

TABLE 2

| TYPE OF RECORDING MATERIAL | XX4200 | CLC105 |
|---|---|---|
| ELASTIC LAYER OF MAGNETIC | Δ | ∘ |
| RUBBER MATERIAL | FAILURE FIXABILITY | FAVORABLE FIXABILITY |
| MAGNETIC FIELD APPLIED | (TONER UNMELTED) | |
| (HIGH HARDNESS) | | |
| ELASTIC LAYER OF MAGNETIC | ∘ | Δ |
| RUBBER MATERIAL | FAVORABLE FIXABILITY | FAILURE FIXABILITY |
| NO MAGNETIC FIELD APPLIED | | (TONER EXCESSIVELY MELT) |
| (LOW HARDNESS) | | |
| COMPARATIVE EXAMPLE | ∘ | Δ |
| ELASTIC LAYER OF SILICON | FAVORABLE FIXABILITY | FAILURE FIXABILITY |
| RUBBER | | (TONER EXCESSIVELY MELT) |

In the case of ‘magnetic field applied’ in Table 2, the opposing distance between the permanent magnets 52 and was 5 mm. In the case of ‘no magnetic field applied’, the opposing distance between the permanent magnets 52 and 54 was 15 mm. The fixing roller in the comparative example in Table 2 was a conventionally soft fixing roller. The soft fixing roller was formed by coating a releasing layer of PFA resin of 50 μm thick around a surface of an elastic layer of silicone rubber (rubber hardness: degree 8 in JIS-A) of 1.0 mm thick. In Table 2, a recording material separation failure after fixation was judged visually by observing stain of the surface layer of the fixing roller 41 caused by the excessive melting.

According to the first embodiment, in the case of the recording material A whose surface irregularities is large, the eccentric cam 61 is rotated to an uppermost position as shown in FIG. 7A to set the opposing distance between the permanent magnets 52 and 54 to 15 mm based on Table 2. This arrangement makes it possible to keep the magnetic rubber layer 41b soft because the magnetic field is not fully applied to the magnetic rubber layer 41b. Meanwhile, in the case of the recording material B whose surface irregularity is small, the eccentric cam 61 is rotated to a lowermost position to set the opposing distance between the permanent magnets 52 and 54 to 5 mm as shown in FIG. 7C. This arrangement makes it possible to harden the magnetic rubber layer 41b by applying the magnetic field fully to the magnetic rubber layer 41b. In a case of a recording material C having irregularities of height between the recording materials A and B, the eccentric cam 61 is rotated to an intermediate position to set the opposing distance between the permanent magnets 52 and 54 to 10 mm as shown in FIG. 7B.

### Nip Width

As shown in FIG. 2, a length in a conveying direction of the nip portion N is increased in a case when the permanent magnet 52 is elevated to soften the magnetic rubber layer 41b as compared to a case when the permanent magnet 52 is lowered to harden the magnetic rubber layer 41b. It is because a crush amount of the magnetic rubber layer 41b increases. Then, if the length in the conveying direction of the nip portion N increases, a heating time at the nip portion N increases and temperature of the recording material also increases, possibly causing excessive melting of the toner.

However, because the elastic layer 42b of the pressure roller 42 is formed of the soft rubber material that is not hardened and curvature of the core metal 41a of the fixing roller 41 is large, the excessive melting of the toner otherwise caused by the change of the length in the conveying direction of the nip portion N did not occur in the first embodiment.

However, if the heating time becomes excessive due to the increase of the length in the conveying direction of the nip portion N, it is possible to reduce the length in the conveying direction of the nip portion N by reducing the pressurizing force of the nip portion N by actuating the gear motor 48m to rotate the eccentric cam 48. It is because the contact/separation mechanism 50, i.e., one exemplary pressure adjustment mechanism, is capable of adjusting a contact pressure of the fixing roller 41 with the pressure roller 42 in the nip portion N.

### Control of First Embodiment

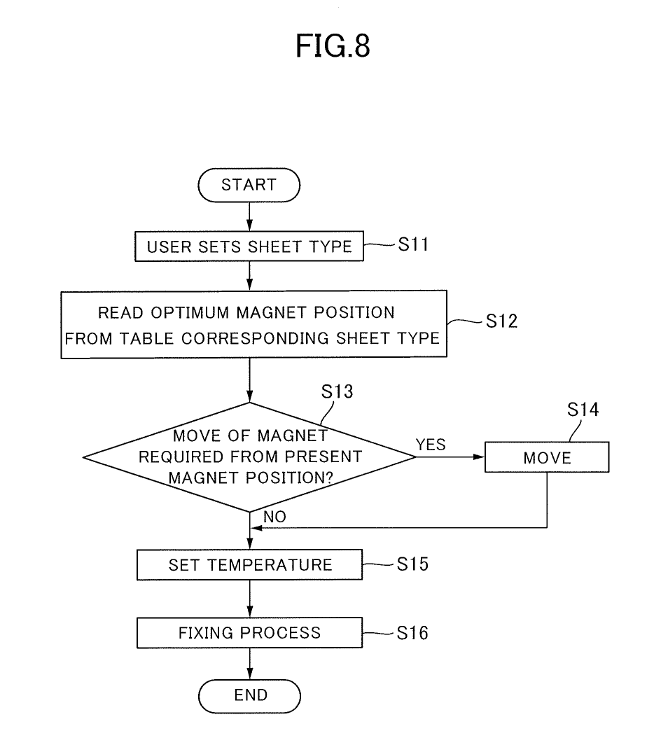

Next, control on a fixing process of the fixing apparatus of the first embodiment will be described. As shown in FIG. 8 with reference to FIG. 3, the user inputs image forming data of a job including a type (sheet type) of the recording material to the control portion 110 through the manipulation panel 120 or the external terminal 200 in Step S11.

Receiving the image forming data of the job, the control portion 110 determines appropriate rubber hardness corresponding to the type of the specified recording material based on a table held in a memory. The control portion 110 determines the opposed distance between the permanent magnets 52 and 54 corresponding to the appropriate rubber hardness based on the table held in the memory in Step S12.

In a case when the determined opposing distance is different from the present opposing distance, i.e., YES in Step S13, the control portion 110 actuates the gear motor 61m to move the permanent magnet 52 to a position of the determined opposing distance in Step S14, then sets a target temperature of the fixing roller 41 in Step S15 and starts a fixing process in Step S16. Meanwhile, if the determined opposing distance is the same with the present opposing distance, i.e., NO in Step S13, the control portion 110 starts the fixing process without actuating the gear motor 61m in Steps S15 and S16. This arrangement makes it possible to set the rubber hardness optimal for the magnetic rubber layer 41b corresponding to the sheet type.

### Another Example of Control of First Embodiment

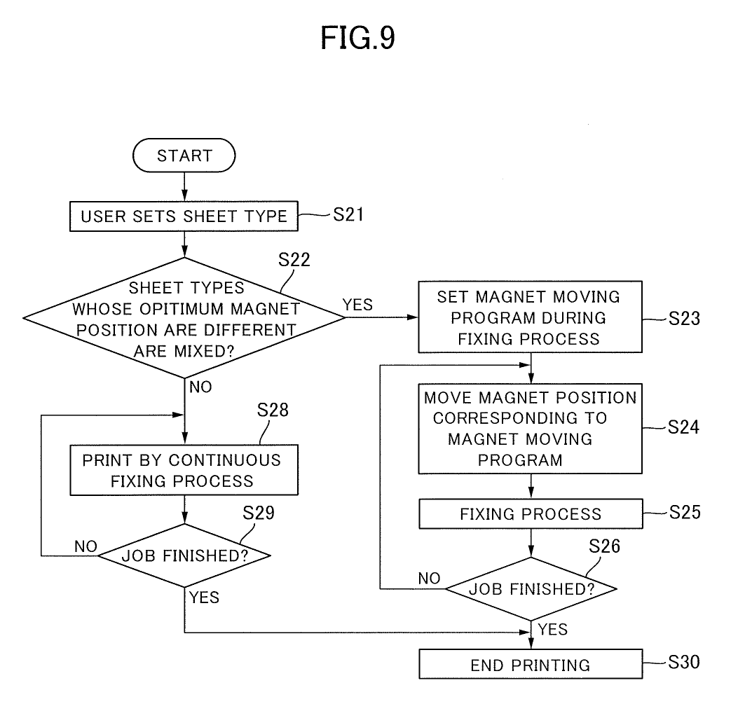

Another example of the control on the fixing process of the fixing apparatus of the first embodiment will be described with reference to FIG. 9. As shown in FIG. 9, according to the another example of the control, the control portion 110 executes the fixing process with a certain rubber hardness during one job in a case when it is not necessary to move the magnet within the job (in a case where different types of sheets are not mixed) by applying the control described with reference to in FIG. 8. However, in a case when the magnet is moved within one job (in a case where different types of sheets are mixed), the control portion 110 sets a magnet moving program at first and executes the fixing process by setting the rubber hardness per change of the sheet type in accordance to the magnet moving program during the job.

More specifically, as shown in FIG. 9 with reference to FIG. 3, the user inputs image forming data of a job including types (sheet types) of recording materials to the control portion 110 through the manipulation panel 120 or the external terminal 200 in Step S21.

The control portion 110 checks the sheet types set by the user in Step S21 to determine whether or not the sheet type is to be changed, requiring the move of the magnet, within the job in Step S22. In a case when no change of the sheet types, requiring the move of the magnet, is to be made (a case where the sheet type is one for example), i.e., NO in Step S22, the control portion 110 executes a printing process in accordance to the flowchart in FIG. 8 setting the magnet position and the target temperature of the fixing roller 41 in Step S28. Then, when the job ends, i.e., YES in Step S29, the control portion 110 finishes the printing process in Step S30.

In a case when the sheet type is to be changed, requiring the move of the magnet (in a case where the sheet type is two for example), i.e., YES in Step S22, the control portion 110 prepares a program of changing the magnet position and the target temperature of the fixing roller 41 during the job corresponding to an order set for recording materials (changes of sheet types) in Step S23. As described above, the smaller the surface roughness of the recording material is, the smoother the surface of the recording material is, and the less the irregularities such as embosses of the recording material is, the closer the permanent magnet is brought to the magnetic rubber layer 41b to increase the magnetic flux incident into the magnetic rubber layer 41b.

The control portion 110 moves the permanent magnet to a position corresponding to the type of the first recording material in Step S24 and starts the fixing process in Step S25. Then, if the job is not finished yet, i.e., NO in Step S26, the control portion 110 changes the magnet position in accordance to the program in Step S24. Then, when the job ends, i.e., YES in Step S26, the control portion 110 finishes the printing process in Step S30.

Accordingly, the control portion 110, i.e., one exemplary information acquiring portion, acquires a model number of the recording material as information corresponding to the surface roughness of the recording material. The control portion 110 controls adjustment mechanism 60 based on the model number of the recording material such that the density of the magnetic flux incident into the magnetic rubber layer becomes lower in a case of the recording material whose surface roughness is first surface roughness than a case of the recording material whose surface roughness is second surface roughness which is smaller than the first surface roughness.

### Relationship Between ΔT and t

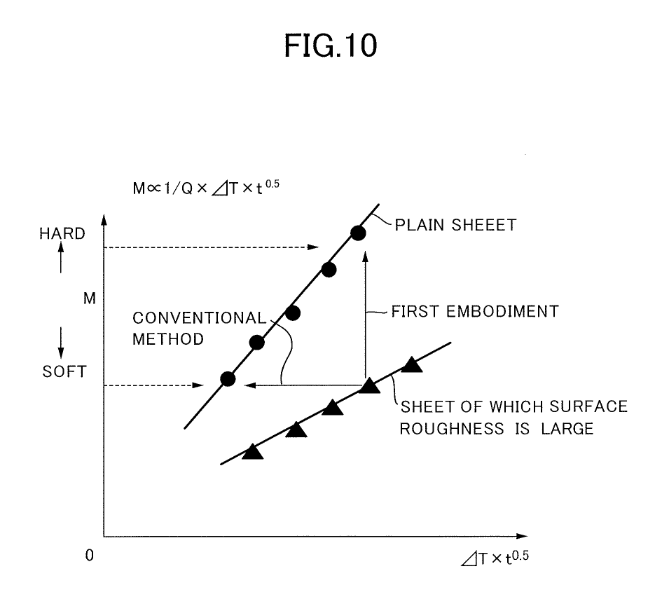

FIG. 10 is a chart illustrating the control made in changing the hardness of the elastic layer. A temperature difference between a target temperature Ta in the temperature adjustment of the fixing apparatus 9 and a recording material temperature Tb before entering the nip portion N will be defined as a heating temperature difference ΔT. The heating temperature difference ΔT is a difference between a lowest fixing temperature by which an optimum fixed image can be obtained and the recording material temperature. Still further, a time (heating time) during which the recording material stays in the nip portion N will be denoted as ‘t’. ‘t’ is a fixing time per each recording material. Here, an index of hardness M indicating the rubber hardness of the magnetic rubber layer 41b of the fixing roller 41 for obtaining the optimum fixed image will be defined as shown in Equation 5:

M=αΔT×(t)^{0.5}+β Eq. 5

In Equation 5, α is a constant of proportionality set corresponding to thermophysical properties of the sheet type, the fixing roller, and toner. When a quantity of heat required for fixing a toner image on a recording material is denoted as Q, α has a relationship of α∝1/Q. β is an index corresponding to a toner melt condition. β takes a different value per toner.

At this time, as shown in FIG. 10, there is a linear relationship between a product of ΔT and square root of t and the index of hardness M if the recording materials are the same. The linear relationship holds per type of the recording material in an approximate line connecting data points of appropriate heating condition obtained by plotting M and a value (ΔT×t^{(1/2)}). Therefore, if the temperature difference (ΔT) before and after heating per each recording material is equal, there is a linear relationship between the square root of t and the index of hardness M. Correlation between each data plot and the approximate curve is said to be high in evaluating the linear relationship by using regression analysis with a correlation coefficient R2(0<R2<1) if a range is R2>0.8. As for the correlation between Equation 5 and each data in FIG. 10, a result of correlation exceeding the correlation coefficient R2>0.9 was obtained.

Then, among the different recording materials, it is desirable to arrange such that the larger an amplitude of the irregularities of the surface or the larger the surface roughness of the recording material, the softer the elastic layer (the lower the index of hardness M) is. According to the present embodiment, it is not necessary to change the target temperature (ΔT) in the temperature adjustment or the fixing time (t) by changing the index of hardness M just by canceling the change of the proportional constant α on the right side of Equation 5.

However, the conventional fixing apparatus (conventional method) is unable to change the hardness of the elastic layer per each recording material. Therefore, according to the conventional method, for the recording material in which the amplitude of irregularities of the surface or the surface roughness is large, the target temperature (ΔT) in heating the fixing roller 41 is raised or a rotation speed of the fixing roller 41 is lowered to prolong the time t during which the recording material stays in the N in order to increase a heating quantity Q of the recording material as indicated by an arrow in FIG. 10.

For instance, in a case of printing on a plain sheet right after a recording material whose surface irregularity is larger than that of the plain sheet or a recording material whose surface roughness is larger than that of the plain sheet, conventionally, the fixing process of the plain sheet was started in a state in which temperature (Q) of the fixing roller 41 was lowered and a printing speed was lowered to shorten a heating time (t). For instance, the fixing process of the plain sheet was started under a condition of t=35 msec. by waiting until when the temperature of the fixing roller 41 drops to a new target temperature (ΔT=160° C.) after fixing under a condition of ΔT=180° C., t=40 msec. on the recording material whose surface roughness is large.

Meanwhile, it is possible to change the hardness of the elastic layer (the magnetic rubber layer 41b) in the first embodiment. Supposing that M is an index of hardness of the magnetic rubber layer corresponding to magnetic flux density, ΔT is a temperature difference between a surface temperature of the fixing roller 41 and a surface temperature of the recording material, and t is a heating time of the recording material at the nip portion N, it is possible to assure optimal fixability in the fixing apparatus 9 at this time by changing the index of hardness M without changing the target temperature (ΔT) of the temperature adjustment and the rotation speed (t) of the fixing roller 41 as indicated by an arrow in FIG. 10. As shown in Table 3 below, it is possible to conduct the fixing process on the plain sheet and the recording material whose surface roughness is large without changing the target temperature (ΔT) and the rotation speed (t) of the fixing roller 41 just by bringing the permanent magnet closer to the permanent magnet 54 to change a magnet relative position, i.e., the opposed distance between the permanent magnets 52 and 54, from 0.00068 to 0.00105 and the index of hardness M=1480 to 947. That is, the control portion 110 can change the density of the magnetic flux incident into the rubber layer by controlling the adjustment mechanism 60 without changing the target temperature and the rotation speed of the fixing roller 41 in continuously heating the different types of recording materials.

TABLE 3

| | FIRST | FIRST | COMPAR- |
|---|---|---|---|
| | EMBODI- | EMBODI- | ATIVE |
| | MENT | MENT | EXAMPLE |
| TYPE OF RECORDING | XX4200 | CLC105 | CLC105 |
| MATERIAL | | | |
| SURFACE CONDITION | EMBOSS | PLAIN | PLAIN |
| WEIGHT PER UNIT AREA | SHEET | SHEET | SHEET |
| | 105[g/m2] | 105[g/m2] | 105[g/m2] |
| TEMPERATURE | 180-25 | 180-25 | 160-25 |
| DIFFERENCE BETWEEN | 155 | 155 | 135 |
| FIXING TEMPERATURE | | | |
| AND TEMPERATURE OF | | | |
| RECORDING MATERIAL | | | |
| ΔT[° C.] | | | |
| HEATING TIME | 40 | 40 | 35 |
| t[msec] | | | |
| INDEX OF HARDNESS | 1480 | 947 | 912 |
| M | | | |
| MAGNET RELATIVE | 0.00068 | 0.00105 | NO |
| POSITION d[—] | | | MAGNETIC |
| | | | FIELD |
| | | | APPLIED |

As described above, it is possible to determine the magnetic field to be applied corresponding to the index of hardness M per each recording material. This relationship is also applicable in the same manner to the following second through fifth embodiments. In a third embodiment employing an electromagnet, an applied current value is changed to change the magnetic flux density. It is noted that although FIG. 10 illustrates the two types of recording materials, the similar relationship holds also in other sheets whose basis weight or surface roughness are different. However, it does not mean that it is possible to approximate all data by Equation 5, and the calculation results in having an error more or less because errors are contained in the measurements of temperature and hardness in general.

It is noted that in a case when a variation width of the softness of the elastic layer is small just by changing the magnetic flux density, it is conceivable to set appropriate fixing conditions by also combining together with the change of the length in the conveying direction of the nip portion N or the change of the target temperature in the temperature adjustment. In such a case, it is possible to control the hardness of the elastic layer, the nip time, and the fixing temperature from Equation 5 described above.

Still further, as shown in FIG. 10, when the type of the recording material subjected to the fixing process is changed, it is possible to change the index of hardness M of the magnetic rubber layer 41b while keeping ΔT and t constant, respectively. However, it is also possible to control so as to change the index of hardness M while changing ΔT and t such that the value (ΔT×t^{(1/2)}) before the type of the recording material is changed is maintained.

### Addition Amount of Filler

According to the first embodiment, the fixing roller 41 has the rubber layer containing 10 to 60 volume % of at least one type of magnetic particles of iron, nickel, cobalt, γ-iron oxide, alnico, ferrite, and neodymium. These numerical values may be reasoned as follows.

Volume fraction of spheres may be calculated theoretically as follows. In a case of a simple cubic lattice in which an equal-diameter particle is positioned at each apex of a hexahedron, the volume fraction is 52 volume %. In a case of a body-centered cubic lattice in which equal-diameter particles exist at a center and each apex of a hexahedron, the volume fraction is 68 volume %. Still further, in a case of a surface-centered cubic lattice in which equal-diameter particles exist at each surface and each apex of a hexahedron, the volume fraction is 74 volume %.

Actually, because the shape of the magnetic particle is not globular precisely and a typical diameter thereof varies, it does not mean that the particles start to bind with these volume fractions. However, if the particles start to bind, not only elasticity as rubber is lost, but also the rubber is liable to be destroyed starting from a part to which pressure is repeatedly applied and released. It was confirmed that a rubber sample becomes brittle if the volume fraction of the fillers exceeds 60 volume % in a group of silicon rubber containing Ni particles of this time. This is why an upper limit of the volume fraction was determined to be 60 volume % here.

Meanwhile, if the amount of the filler added into the rubber is reduced, while the original elasticity of the rubber is liable to be exhibited, the magnetic coupling between the fillers caused by magnetic force becomes weak. It is known that a force between two particles is inversely proportional to a square of a distance from the Coulomb's law of magnetism.

Still further, in a case when the rubber layer is used as the elastic layer of the fixing roller, the fillers also play a role of increasing thermal conductivity of the silicon rubber by being added into the silicon rubber. Thermal conductivity of the silicon rubber is low as compared to that of the fillers and is 0.2 (W/m/K). While the fillers are added to the silicon rubber to enhance the thermal conductivity of the silicon rubber, the thermal conductivity when the Ni powder is added by 10 volume % can be calculated from the equation of Rayleigh-Maxwell as follows (Study Report of Electrotechnical Laboratory (Japan) No. 176, Thermal Conductivity of Polymeric Material, Katsuhiko Kinjo, p. 34):

λ=λc((2λc+λd−2Φ(λc−λd))/(2λc+λd+Φ(λc−λd))

Here, λc is the thermal conductivity of the silicon rubber and is 0.2 (W/m/K). λd is thermal conductivity of Nickel and is 90 (W/m/K). In the case when the volume fraction of Nickel is 10 volume %, the thermal conductivity λ becomes 0.26 (W/m/K) and it can be seen that heat transfer characteristics is barely enhanced when the addition amount of Nickel is less than 10 volume % with respect to the thermal conductivity λc of the silicon rubber. Accordingly, a lower limit of the volume fraction is set to be 10 volume % here.

### Hardness of Elastic Layer

A range of the hardness of the elastic layer in which the fillers are added to the silicon rubber as described above is preferable to be more than 40° and less than 95° in terms of measured values of a micro durometer. If the hardness of the elastic layer is too hard, the surface of the roller cannot follow the irregularities of a sheet, and non-fixed parts are left on the sheet. Meanwhile, if the elastic layer is too soft, a sheet separation failure is liable to occur after the fixing process.

As a method for measuring the hardness of the elastic layer, a rubber hardness meter of a type of pressing a stylus is used after molding the rubber into a shape of a roller or a belt as a fixing member and rubber hardness measured by the rubber hardness meter. Various makers propose the rubber hardness meter of the stylus type such as JIS-A type and C type. While a micro rubber hardness meter MD-1 (TYP-C) manufactured by Kobunshi Keiki Co., Ltd. was used this time, other meter may be used as well. Because measured values of the rubber hardness meter include errors due to measurement errors and to unevenness of material of the rubber itself, arbitrarily selected different positions were measured by five times, and an average value thereof was adopted as a typical value.

Table 4 shows judged results of image quality and separation failure with respect to each rubber hardness measure measured by the hardness meter MD-1 (TYP-C) as described above. In Table 4, the image quality was judged by visually observing whether or not fixing failure is left after transferring a uniform density image (solid image) on a recording material and fixing it. Criterion was made so as to mark as x to ones in which a large number of fixing failure was seen, as Δ to ones in which several parts of fixing failure were seen, and as O to ones in which no fixing failure was seen. In terms of the separation failure, ones in which the recording material is wound around the fixing roller after fixing were judged to be x and ones in which the recording material separates without winding around the roller were marked as O.

TABLE 4

| RUBBER HARDNESS OF | IMAGE QUALITY | FIXING ROLLER |
|---|---|---|
| ELASTIC LAYER (°) | AFTER FIXATION | SEPARABILITY |
| 95 | Δ | ∘ |
| 90.2 | ∘ | ∘ |
| 68.7 | ∘ | ∘ |
| 48.5 | ∘ | ∘ |
| 40 | ∘ | Δ |
| 8.4 | x | x |

According to the first embodiment described above, the control portion 110 changes the hardness of the rubber layer by controlling the density of the magnetic flux acting on the rubber layer, so that it is possible to heat the toner image favorably on the both of the recording material for which the soft rubber layer is preferable and the recording material for which the hard rubber layer is preferable.

Then, the arrangement of the present embodiment makes it possible to print high quality images on recording materials continuously without dropping productivity while maintaining the optimal toner melt condition even in a mixed printing process in which the sheet type changes per sheet. It becomes possible to reliably fix the recording materials by quickly applying an optimal heat quantity in the printing process in which sheet types are mixed. Because the hardness of the magnetic rubber layer 41b can be changed instantly, it is possible to deal with even a printing process in which two types of sheets are mixed one by one without dropping productivity.

### Second Embodiment

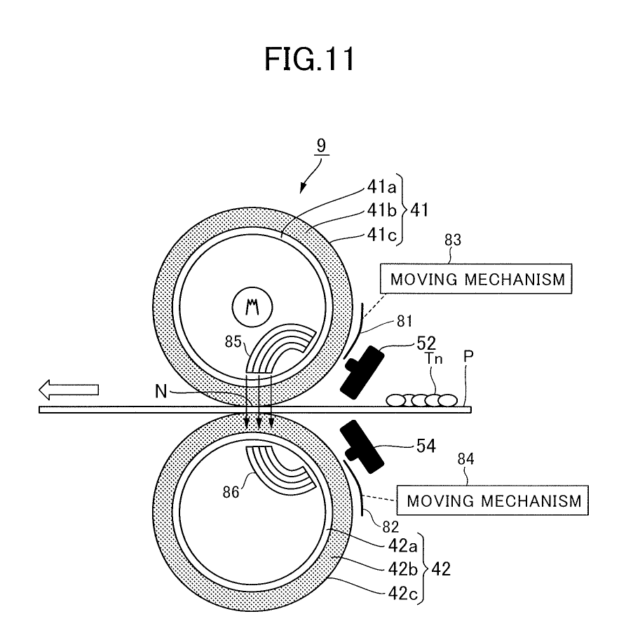

A fixing apparatus of a second embodiment will be described with reference to FIG. 11. In the first embodiment, an amount of magnetic flux incident into the magnetic rubber layer 41b was adjusted by adjusting the inter-magnetic pole distance of the pair of permanent magnets. Whereas, according to the second embodiment, an amount magnetic flux incident into the magnetic rubber layer 41b is adjusted by restricting the magnetic flux incident into the magnetic rubber layer 41b from the permanent magnet by using shutters formed of a magnetic flux blocking material. The fixing apparatus of the second embodiment is constructed and controlled in the same manner with the first embodiment except that the disposition of the permanent magnets and the magnetic flux adjustment method are different. Therefore, components and controls in FIG. 11 similar to those of the first embodiment will be denoted by the common reference numerals with those of FIG. 2 and an overlapped explanation thereof will be omitted here.

As shown in FIG. 11, the pressure roller 42 is brought into pressure contact with the fixing roller 41 to form the nip portion N nipping the recording material. The core metal 41a of the fixing roller 41 is formed of an aluminum cylinder whose outer diameter is 38 mm and is 1 mm thick. The magnetic rubber layer 41b is molded by using a magnetic elastomer of 2.0 mm thick in which fine powder of iron oxide Fe₃O₄ is blended as fillers into an elastomer of silicon rubber. A fluororesin tube of 50 μm thick was used as the releasing layer 41c. The core metal 42a of the pressure roller 42 is formed of an aluminum cylinder whose outer diameter is 38 mm and is 1 mm thick. The elastic layer 42b is molded by using a magnetic elastomer of 2.0 mm thick in which fine powder of iron oxide Fe₃O₄ is blended as fillers into an elastomer of silicon rubber. A fluororesin tube of 50 μm thick was used as the releasing layer 42c.

Shutters 81 and 82 are plate members formed of a magnetic metal (soft steel). The shutters 81 and 82 are moved by moving mechanisms 83 and 84 and partially block magnetic flux incident into the magnetic rubber layer 41b from the permanent magnets 52 and 54. The control portion 110 controls the moving mechanism 83 to move the shutter 81 to an optimal position corresponding to a type of the recording material.

Magnetic circuits 85 and 86 are formed of a magnetic member (soft steel for example) whose magnetic permeability is high and whose coercive force is small, and increase magnetic flux passing through the nip portion N by forming magnetic paths between the permanent magnets 52 and 54. It is also possible to change a shape of the magnet into a convex shape to concentrate the magnetic field at a convex apex portion.

In the case of providing the magnetic field blocking plate between the permanent magnet and the magnetic rubber material in order to change the hardness of the magnetic rubber material, it is preferable to user a magnetic body such as iron as the magnetic field blocking plate. Although it is possible to weaken the magnetic field also by using a non-magnetic body, a certain degree of thickness is required.

### Third Embodiment

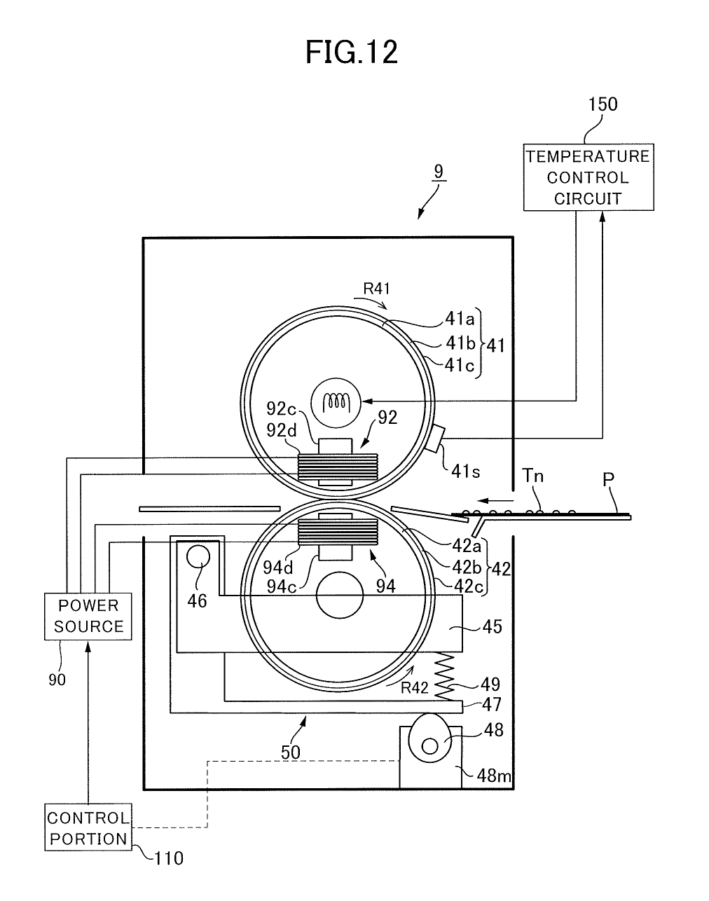

A fixing apparatus of a third embodiment will be described with reference to FIG. 12. In the first embodiment, the magnetic flux formed between the pair of permanent magnets were used to harden the elastic layer (41b) made of the magnetic rubber material. Whereas, in the third embodiment, the magnetic flux formed between a pair of electromagnets are used to harden the elastic layer (41b) of the magnetic rubber material. The fixing apparatus of the third embodiment is constructed and controlled in the same manner with the first embodiment except that the permanent magnets are replaced with the electromagnets. Therefore, components and controls in FIG. 12 similar to those of the first embodiment will be denoted by the common reference numerals with those of FIG. 2 and an overlapped explanation thereof will be omitted here.

As shown in FIG. 12, the electromagnet 92 is constructed by winding a coil 92d around a magnetic core 92c. The electromagnet 94 is constructed by winding a coil 94d around a magnetic core 94c. A power source 90 applies DC current to the coils 92d and 94d to generate a magnetic field and to generate magnetic flux between the magnetic cores 92c and 94c so as to be incident into the magnetic rubber layer 41b. The control portion 110 controls the power source 90 and can change the magnetic flux density, including generation/non-generation of the magnetic flux incident into the magnetic rubber layer 41b.

It is equal to decrease the electric current flown to the coils 92d and 94d in FIG. 12 to elevate the permanent magnet 52 to increase an opposing distance with the permanent magnet 54 in FIG. 2. Meanwhile, it is equal to increase the electric current flown to the coils 92d and 94d in FIG. 12 to lower the permanent magnet 52 to reduce the opposing distance with the permanent magnet 54 in FIG. 2. It is equal to turn OFF the electric current flown to the coils 92d and 94d to pull out the permanent magnets 52 and 54 or to fully increase the opposing distance as shown in FIG. 7A described above. Accordingly, the program (S23) for moving the permanent magnet 52 during a job described in the flowchart in FIG. 9 corresponds to the program for switching the electric current of the coils 92d and 94d in the structure shown in FIG. 12.

In the case of applying the magnetic field to the magnetic rubber material using the DC electromagnets, the magnetic flux density B may be expressed as follows:

B=μH=μnI

Where, μ is the magnetic permeability, n is a number of turns of the coil, and I is a current value. Accordingly, it is possible to control the magnetic flux density B by the number of turns of the coil n and the current value I. The power source 90 which is one exemplary switching portion can configure to switch ON/OFF or to change the current value of the electric current applied to the electromagnets 92 and 94, i.e., one exemplary magnetic flux generate portions.

### Fourth Embodiment

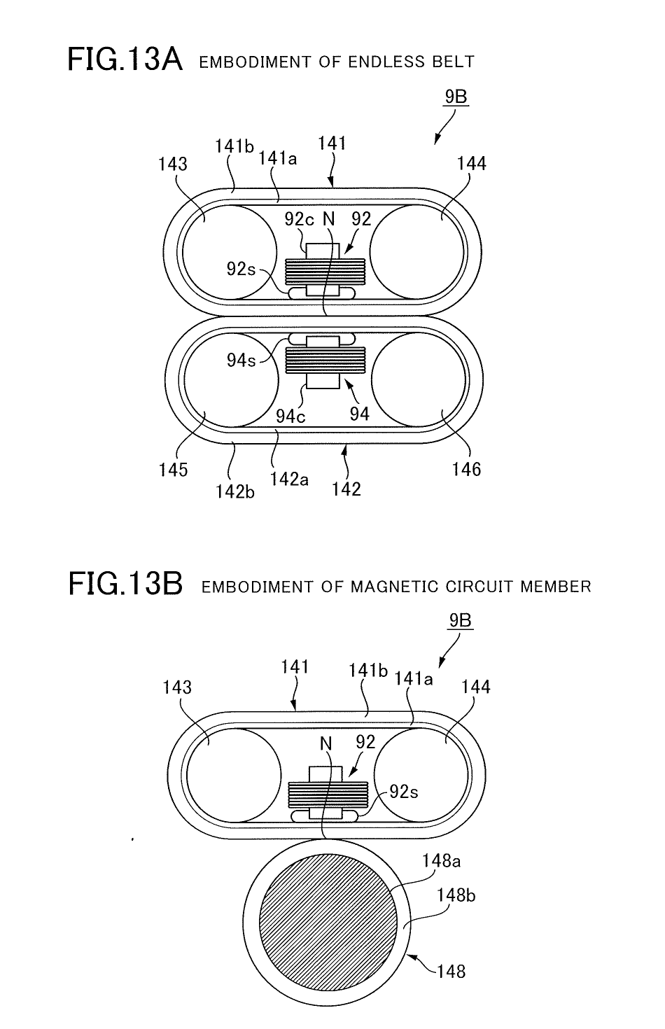

A fixing apparatus of a fourth embodiment will be described with reference to FIGS. 13A and 13B. According to the third embodiment, the magnetic rubber layer 41b is supported by a cylindrical core metal 41a made of a non-magnetic material as shown in FIG. 12. Whereas, according to a fourth embodiment, the magnetic rubber layer 141b formed of a magnetic rubber material is supported by an endless belt 141a made of a non-magnet material as shown in FIG. 13A.

As shown in FIG. 13A, the fixing belt 141 is constructed by forming the magnetic rubber layer 141b of 300 μm thick around an outer circumferential surface of an endless belt 141a made of polyimide of 100 μm thick. The magnetic rubber material is what described in the first embodiment. The endless belt 141a is stretched by a driving roller 144 driven by a motor not shown and a tension roller 143 whose both ends are supported by tension springs not shown.

A pressure belt 142 is constructed by forming the elastic layer 142b of silicon rubber of 300 μm thick around an outer circumferential surface of an endless belt 142a made of polyimide of 100 μm thick. The endless belt 142a is stretched by a driving roller 146 driven by a motor not shown and a tension roller 145 whose both ends are supported by tension springs not shown.

The magnetic cores 92c and 94c of the electromagnets 92 and 94 described in the third embodiment are provided with sliders 92s and 94s made of fluororesin material whose frictional force is low so as to cover opposing surfaces of the magnetic cores 92c and 94c and to form the nip portion N where an overlapped part of the fixing belt 141 and the pressure belt 142 is pressed.

It is noted that the electromagnet 92 within the fixing belt 141 or the electromagnet 94 within the pressure belt 142 may be replaced with a magnetic circuit member 148a as shown in FIG. 13B. The pressure roller 148 is constructed by forming an elastic layer 148b made of silicon rubber around a round bar, functioning also as a core metal, made of soft steel whose magnetic permeability is high and coercive force is small. It is also possible to dispose another magnet circuit member communicating end faces projecting from both ends of the pressure roller 148 of the magnetic circuit member 148a with magnetic poles of the magnetic core 92c of the electromagnet 92.

That is, in a case when the electromagnet 92 is disposed within an inner space of the fixing belt 141, i.e., one example among the first and second rotators, the magnetic circuit member 148a, i.e., one example of the magnetic member, may be disposed in an inner space of the pressure roller 148, i.e., another example. It is because this arrangement readily enhances the density of the magnetic flux incident into the magnetic rubber layer 141b.

According to the fourth embodiment, it is possible to harden the magnetic rubber layer 141b by using the magnetic flux formed between the pair of electromagnets 92 and 94 as same to the third embodiment. Still further, it is possible to soften the magnetic rubber layer 141b by turning OFF the electric current flown through the coils 92d and 94d and to fix a toner image even into concave portions of fibers of the recording material whose surface irregularity is large such as an embossed sheet.

### Fifth Embodiment

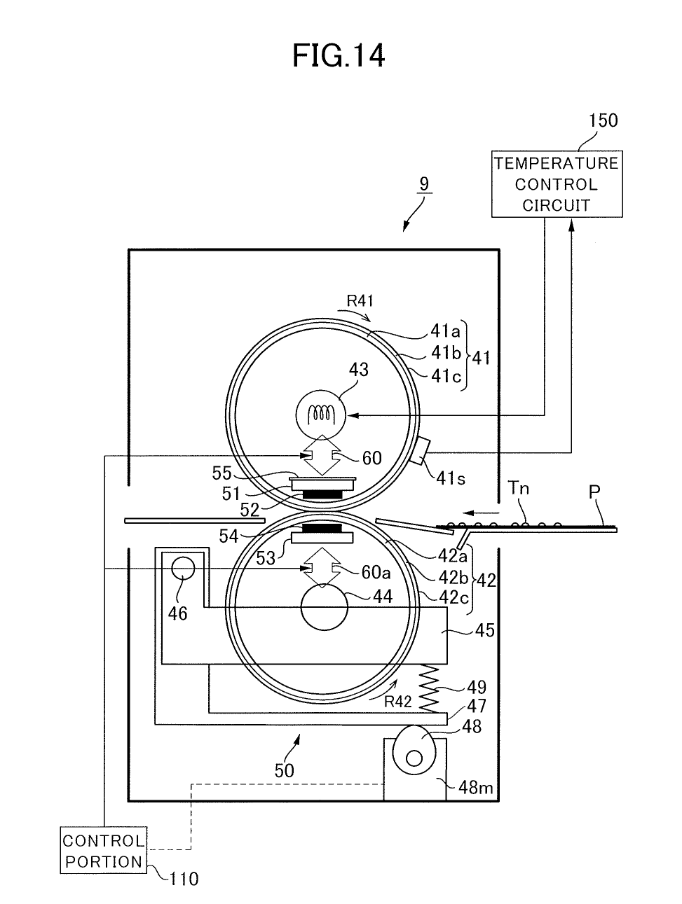

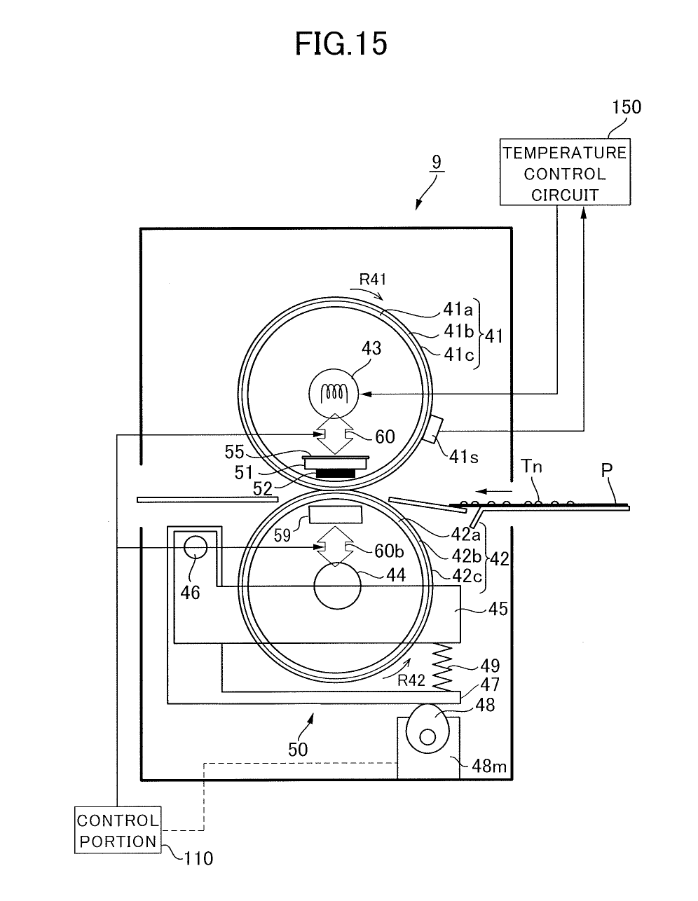

A fixing apparatus of a fifth embodiment will be described below with reference to FIGS. 14 and 15. In the first embodiment, the configuration in which the permanent magnet 52 disposed in the inner space of the fixing roller is moved has been described. Whereas, the permanent magnet 54 disposed in the inner space of the pressure roller 42 is also moved to change the distance between the permanent magnet 54 and the nip portion N as shown in FIG. 1n the fifth embodiment. To that end, the fixing apparatus of the fifth embodiment includes an adjustment mechanism 60a, similar to the adjustment mechanism 60 described in the first embodiment, to move the permanent magnet 54.

In FIG. 15, instead of the permanent magnet 54, a magnetic member 59 is disposed in the inner space of the pressure roller 42. Then, the magnetic member 59 is moved to change a distance between the magnetic member 59 and the nip portion N. To that end, the magnetic member 59 is moved by the adjustment mechanism 60b, similarly to the adjustment mechanism 60 described in the first embodiment. In the case of the configurations shown in FIGS. 14 and 15, it is possible to switch the density of the magnetic flux incident into the magnetic rubber layer 41b, similarly to the first embodiment, by moving the permanent magnet 54 or the magnetic member 59. It is noted that in the configurations shown in FIGS. 14 and 15, the adjustment mechanism 60 moving the permanent magnet 52 may be omitted.

### Sixth Embodiment

A fixing apparatus of a sixth embodiment will be described below. When the hardness of the elastic layer changes, the length in the conveying direction of the nip portion N also may change. For instance, if the elastic layer is softened under an equal pressurizing force, the length in the conveying direction of the nip portion N increases.

Then, according to the sixth embodiment, the change of the length in the conveying direction of the nip portion N occurring along with the change of the hardness of the elastic layer of the magnetic rubber material is actively used to change the stay time of the recording material in the nip portion N and to adjust a heating quantity of the recording material without changing a conveying speed.

As shown in FIG. 12, the fixing roller 41 is constructed by providing the magnetic rubber layer 41b of 2 mm thick and made of the magnetic rubber material around the core metal 41a of 76 mm in diameter and made of a non-magnetic metallic material, and by coating the circumferential surface of the magnetic rubber layer 41b by the releasing layer 41c formed of the fluororesin material. The pressure roller 42 is constructed by providing the elastic layer (magnetic rubber layer) 42b of 2 mm thick and made of the magnetic rubber material around the core metal 42a of 76 mm in diameter and made of a non-magnetic metallic material and by coating the circumferential surface of the elastic layer (magnetic rubber layer) 42b by the releasing layer 42c formed of the fluororesin material.

That is, the fixing roller 41 includes a base layer made of the non-magnetic material and positions the magnetic rubber layer around the base layer. The pressure roller 42 includes a base layer made of the non-magnetic material and positions the magnetic rubber layer made of the magnetic rubber material in which magnetic particles are dispersed in the rubber material around the base layer similarly to the fixing roller 41.

The control portion 110, i.e., one exemplary information acquiring portion, acquires a model number of a recording material as information corresponding to weight per unit area of the recording material. The control portion 110 controls the adjustment mechanism 60 based on the model number of the recording material. In a case of a recording material whose weight per unit area is first weight, the control portion 110 increases the density of the magnetic flux incident into the magnetic rubber layer 41b and the elastic layer (magnetic rubber layer) 42b more than a case of a recording material whose weight per unit area is second weight which is heavier than the first weight. The control portion 110 controls the electric current applied to the electromagnets 92 and 94 to change the density of the magnetic flux incident into the magnetic rubber layer 41b and the elastic layer (magnetic rubber layer) 42b. Thereby, the hardness of the magnetic rubber layer 41b and the elastic layer (magnetic rubber layer) 42b changes, and the length in the conveying direction of the nip portion N changes even under the equal pressurizing force.

According to the embodiments described above, it is possible to execute the fixing process without changing printing speed or without halting the printing process even if recording materials in which heights of irregularities of the surface are different are mixed. Therefore, it is possible to realize a highly productive image forming apparatus provided with the high speed printing function.

Meanwhile, according to the sixth embodiment, it is possible to execute the fixing process of images on different types of recording materials without changing the target temperature in the temperature adjustment and the rotation speed of the fixing roller 41 just by controlling the adjustment mechanism 60 to change the density of the magnetic flux incident into the magnetic rubber layer. Accordingly, even in a case in which thick and thin sheets are mixed for example, it is possible to execute the fixing process of the respective sheets without changing the printing speed (process speed) to assure a quantity of heat corresponding to the type of the sheet in the fixing apparatus 9. Accordingly, it is possible to eliminate a downtime required for adjustment otherwise required to response to the change of the printing speed.

According to the sixth embodiment, it is possible to assure an enough contact condition for both of the thick and thin sheets and to apply an adequate quantity of heat without switching the pressure of the pressure roller 42 against the fixing roller 41, the conveying speed, and the temperature setting. It is possible to execute the optimal fixing process without changing the fixing temperature (ΔT) and the fixing time (t) just by using the magnetic rubber layer 41b which is softer (the index of hardness M is lower) for the recording material whose weight per unit area is larger according to Equation 5 described above. This arrangement makes it also possible to prevent fixing failures from otherwise occurring by excessive melting of the toner by applying an excessive quantity of heat to the recording material or by insufficient melting of the toner by applying an insufficient quantity of heat to the recording material in contrary.

Because the length in the conveying direction of the nip portion N changes concurrently with ON/OFF of the electric current applied to the electromagnets 92 and 94 in the sixth embodiment, it is possible to change the heating quantity even in a case where different types of sheets are mixed alternately one by one. Because the nip passing time of the recording material can be adjusted by changing the length in the conveying direction of the nip portion N, it is easy to change the heating quantity per sheet without changing the printing speed. It is noted that if the printing speed is changed in changing the heating quantity, a great downtime is required for adjustment of the respective components in response with the change of the printing speed because the image forming portion is also required to change the printing speed.

According to the sixth embodiment, because the fixing process can be implemented without widening a printing interval to deal with a waiting time for the temperature adjustment and a waiting time to change the length of the nip portion N, the productivity of the image forming apparatus 100 can be improved. The sixth embodiment is suitable for commercial printing in which booklets in which several sheet types such as cover sheets and inner sheets are mixed are more often printed.

### Other Embodiment

The present invention is not limited to the configurations and controls of the first through sixth embodiments. The numerical values and others used in the description of the first through sixth embodiments are just exemplary ones, and the present invention is not limited by those numerical values and others.

Still further, it is desirable to form the magnetic rubber layer by using the silicon rubber in which nickel fine particle of more than 30% and less than 60% in weight ratio is blended. It is because the rubber hardness becomes too low when the magnetic flux is generated in the case when the weight ratio of the nickel fine particle is 30% or less and the rubber hardness becomes too high when the magnetic flux is not generated in the case when the weight ratio is 60% or more.

Still further, the combination of the first and second rotators is not limited to the combination of the identical cylinders or of the endless belts. It is possible to adopt a combination of the first rotator formed into a cylindrical shape and the second rotator formed into the endless belt.

Still further, in the case of disposing the magnetic flux generate portion in one of the first and second rotator and the magnetic member in another one, the magnetic member may be disposed movably in the inner space of the other one. It is because it is possible to change the density of the magnetic flux incident into the magnetic rubber layer by moving the magnetic member so as to change the distance between the magnetic member and the nip portion N.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-241214, filed Nov. 28, 2014, which is hereby incorporated by reference herein in its entirety.

What is claimed is:

1. An image forming apparatus, comprising:
a heating rotator configured to heat a toner image formed on a recording material at a nip portion, the heating rotator including a rubber layer containing 10 to 60 volume % of at least one of magnetic particles of iron, nickel, cobalt, γ-iron oxide, alnico, ferrite, and neodymium;
a magnetic flux generate portion configured to generate magnetic flux; and
a control portion configured to control density of the magnetic flux acting on the rubber layer from the magnetic flux generate portion.

2. The image forming apparatus according to claim 1, wherein the control portion controls the density of the magnetic flux acting on the rubber layer corresponding to a type of the recording material.

3. The image forming apparatus according to claim 2, wherein the control portion controls the density of the magnetic flux acting on the rubber layer from the magnetic flux generate portion corresponding to surface roughness of the recording material.

4. The image forming apparatus according to claim 3, wherein the control portion controls the density of the magnetic flux such that the density of the magnetic flux being incident into the rubber layer is higher in a case of a recording material whose surface roughness is a first surface roughness than a case of a recording material whose surface roughness is a second surface roughness which is smaller than the first surface roughness.

5. An image heating apparatus, comprising:
a first rotator including a rubber layer in which magnetic particles are dispersed and configured to come into contact with a surface on a side of bearing a toner image of a recording material;
a second rotator configured to form a nip portion nipping the recording material between the first and second rotators;
a heating portion configured to heat the first rotator to heat a toner image formed on the recording material at the nip portion;
a magnetic flux generate portion configured to generate magnetic flux incident into the rubber layer at the nip portion; and
a switching portion configured to switch density of the magnetic flux generated by the magnetic flux generate portion and being incident into the magnetic rubber layer.

6. The image heating apparatus according to claim 5, wherein the magnetic flux generate portion is a permanent magnet.

7. The image heating apparatus according to claim 6, wherein the first rotator is formed into a shape of a cylinder or an endless belt,
wherein the second rotator is formed into a shape of a cylinder or an endless belt, and
wherein the magnetic flux generate portion is disposed in an inner space of one of the first and second rotators.

8. The image heating apparatus according to claim 7, further comprising a second magnetic flux generate portion, differing from the magnetic flux generate portion as a first magnetic flux generate portion, configured to generate magnetic flux incident into the rubber layer at the nip portion,
wherein the first magnetic flux generate portion is disposed within an inner space of the first rotator, and
wherein the second magnetic flux generate portion is disposed within an inner space of the second rotator such that a magnetic pole of the second magnetic flux generate portion, different from a magnetic pole of the first magnetic flux generate portion, faces the magnetic pole of the first magnetic flux generate portion while interposing the nip portion between the magnetic poles of the first and second magnetic flux generate portions.

9. The image heating apparatus according to claim 8, wherein the switching portion is a moving mechanism configured to move at least either one of the first and second magnetic flux generate portions such that a distance between the nip portion and at least either one of the first and second magnetic flux generate portions is changed.

10. The image heating apparatus according to claim 7, further comprising a magnetic member disposed in an inner space of another one of the first and second rotators.

11. The image heating apparatus according to claim 10, wherein the switching portion is a moving mechanism configured to move the magnetic flux generate portion such that a distance between the nip portion and the magnetic flux generate portion is changed.

12. The image heating apparatus according to claim 10, wherein the switching portion is a moving mechanism configured to move the magnetic member such that a distance between the magnetic member and the nip portion is changed.

13. The image heating apparatus according to claim 5, wherein the magnetic flux generate portion is an electromagnet.

14. The image heating apparatus according to claim 13, wherein the switching portion is a power source configured to switch ON/OFF or to change a current value of an electric current applied to the electromagnet.

15. The image heating apparatus according to claim 5, further comprising a pressure adjustment mechanism configured to adjust a contact pressure between the first and second rotators at the nip portion.

16. The image heating apparatus according to claim 5, wherein the rubber layer of the first rotator contains 10 to 60 volume % of at least one of magnetic particles of iron, nickel, cobalt, γ-iron oxide, alnico, ferrite, and neodymium.

17. The image heating apparatus according to claim 5, wherein the second rotator includes a rubber layer in which magnetic particles are dispersed.

18. An image forming apparatus, comprising;
the image heating apparatus as set forth in claim 5; and
a control portion configured to control the switching portion.

19. The image forming apparatus according to claim 18, wherein a linear relationship holds per each type of the recording material in an approximate line connecting data points obtained by plotting M and a value (ΔT×t^{(1/2)}), where M is an index of hardness of the magnetic rubber layer when the magnetic flux density is changed, ΔT is a temperature difference between a surface temperature of the first rotator and a surface temperature of the recording material, and t is a heating time of the recording material at the nip portion, and
wherein the control portion controls the switching portion so as to keep the value (ΔT×t^{(1/2)}) before the type of the recording material is changed and to change the index of hardness M in response to the change of the type of the recording material subject to the fixation.

20. The image forming apparatus according to claim 18, wherein the control portion controls the switching portion such that the density of the magnetic flux being incident into the rubber layer is lower in a case of a recording material whose surface roughness is a first surface roughness than a case of a recording material whose surface roughness is a second surface roughness which is smaller than the first surface roughness.

21. The image forming apparatus according to claim 18, wherein the control portion controls the switching portion such that the density of the magnetic flux being incident into the rubber layer is higher in a case of a recording material whose weight per unit area is a first weight than a case of a recording material whose weight per unit area is a second weight heavier than the first weight.

22. The image forming apparatus according to claim 18, wherein the control portion controls the switching portion to change the density of the magnetic flux incident into the rubber layer without changing a target temperature and a rotation speed of the first rotator in continuously heating different types of recording materials.
